(19) United States
(12) Patent Application Publication
(10) Pub. No.: US 2024/0308282 A1
(43) Pub. Date: Sep. 19, 2024

(54) AUTOMATIC AND ON DEMAND TOW HOOK STOWING AND DEPLOYMENT

(71) Applicant: Toyota Motor Engineering & Manufacturing North America, Inc., Plano, TX (US)

(72) Inventors: Ryan C. Harris, Saline, MI (US); Scott L. Frederick, Brighton, MI (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 18/121,497

(22) Filed: Mar. 14, 2023

(51) Int. Cl. B60D 1/24; B60D 1/04; B60D 1/54

(52) U.S. Cl. CPC B60D 1/246; B60D 1/04; B60D 1/54

(57) ABSTRACT

Methods, systems, and apparatus for a tow hook system for a vehicle. The tow hook system includes a sensor configured to detect a collision of the vehicle and an electronic control unit coupled to the sensor. The electronic control unit is configured obtain, from the sensor, the collision detection, and activate a tow hook assembly based on the collision detection.

### FIELD

This disclosure relates to stowing and deployment of tow hooks on a vehicle.

### DESCRIPTION OF THE RELATED ART

Recovery hooks or tow hooks are common on many vehicles including trucks. These are commonly used to recover vehicles that become stuck while off-roading or in heavy snow or mud. These hooks often protrude from the front bumper of the vehicle for ease of attaching the recover straps. These tow hooks however negatively affect the aerodynamics and the crash performance of the vehicle (small overlap, frontal crash, angled rigid barrier, pedestrian impact, etc.).

Accordingly, there is a need for a system for providing a tow hook that is functional for recovery, which does not negatively impact the vehicle performance during driving and during a collision.

### SUMMARY

In general, one aspect of the subject matter described in this disclosure may be embodied in a tow hook system for a vehicle. The tow hook system includes a sensor configured to detect a collision of the vehicle and an electronic control unit coupled to the sensor. The electronic control unit is configured to obtain, from the sensor, collision detection data, and activate (e.g., retract) a tow hook or a tow hook assembly based on the collision detection data.

In another aspect, the subject matter may be embodied in a tow hook assembly of a vehicle. The tow hook assembly includes a housing coupled to a frame of the vehicle, a tow hook having a distal end and a proximal end opposite the distal end, and a pneumatic actuator coupled to the tow hook. The housing has a first end, a second end opposite the first end, and an opening. The tow hook is at least partially housed in the housing such that the tow hook is configured to move through the opening of the housing between the first end and the second end. The pneumatic actuator is configured to cause the movement of the tow hook into and out of the housing.

In another aspect, the subject matter may be embodied in a method for operating the tow hook assembly of a vehicle. The method includes determining, by a processor, to activate a tow hook assembly in response to a sensor detecting a collision of the vehicle, actuating, by the processor, a pneumatic actuator of the tow hook assembly in response to the collision detection, and stowing, via the pneumatic actuator, a tow hook coupled to the pneumatic actuator.

### BRIEF DESCRIPTION OF THE DRAWINGS

Other systems, methods, features, and advantages of the present invention will be apparent to one skilled in the art upon examination of the following figures and detailed description. Component parts shown in the drawings are not necessarily to scale, and may be exaggerated to better illustrate the important features of the present invention.

FIG. 1 is a block diagram of an example tow hook system according to an aspect of the invention.

FIG. 2 is a schematic diagram of a tow hook assembly of the tow hook system of FIG. 1 is a deployed position according to an aspect of the invention.

FIG. 3 in a schematic diagram of a tow hook assembly of the tow hook system of FIG. 1 in a stowed position according to an aspect of the invention.

FIG. 4 is a flow diagram of an example process for using the tow hook system of FIG. 1 according to an aspect of the invention.

### DETAILED DESCRIPTION

Disclosed herein are systems, vehicles and methods for stowing and deploying a tow hook on a vehicle that is functional, while eliminating any negative impact on the vehicle performance during driving and during a collision. Particular embodiments of the subject matter described in this disclosure may be implemented to realize one or more of the following advantages. The tow hook system may include a tow hook that can deploy and stow automatically or on command. For instance, the tow hook system may include a spring-actuated assembly with electronic deployment and an airbag sensor. When the vehicle or a sensor senses an impending collision, the tow hook system is automatically stowed away to reduce any excessive damage to the vehicle during a collision. When the vehicle or a sensor detects that a speed of the vehicle is greater than a threshold speed (e.g., 30 mph), the tow hook system is automatically stowed away to reduce any excessive drag on the vehicle to improve aerodynamics.

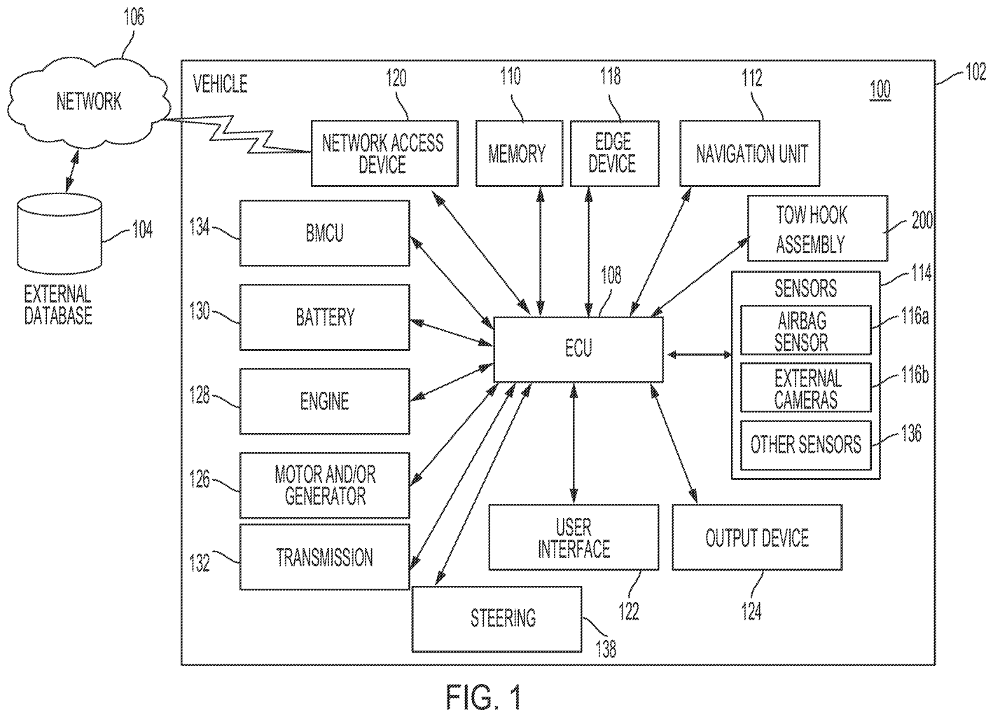

FIG. 1 is a block diagram of a tow hook system 100. The tow hook system 100 monitors sensors (e.g., collision, speed, etc.) of the vehicle and deploys a tow hook assembly 200 of the tow hook system 100 in response to the sensors detecting a specific event (e.g., a collision, a greater speed, etc.). For instance, the tow hook system 100 may be coupled to an airbag sensor. In the event of a crash, the airbag sensor or secondary sensor will detect a crash which activates an actuator and retract a tow hook, as explained further herein. This allows the crash structure of the vehicle 102 to function without being negatively impacted by the tow hook structure. Further, a user may retain the ability to deploy or retract the tow hook as needed using a button. For example, the driver can keep the tow hook stowed and electronically deploy the tow hook when needed for vehicle recovery.

The tow hook system 100 may be retro-fitted, coupled to, include or be included within or on a vehicle 102. The tow hook system 100 may also couple to, connect to, or include an external database 104. The tow hook system 100 may connect to a network 106 that links the external database 104 with the vehicle 102. The network 106 may be a local area network (LAN), a wide area network (WAN), a cellular network, the Internet, or combination thereof, that connects, couples and/or otherwise communicates between the vehicle 102 and the external database 104.

The tow hook system 100 may couple to, connect to, or include an internal edge computing device 118 for rapid and efficient processing at the location of the load within the vehicle 102. The internal edge computing device 118 may include one or more of a central processing unit (CPU), a graphics processing unit (GPU), a tensor processing unit (TPU), a neural processing unit (NPU), etc. The edge computing device 118 may include a relational database or behavioral model database that provides models of normal motions and/or features of different objects or individuals. The edge computing device 118 may be updated and/or provide updates in real-time. The edge computing device 118 may store and/or provide the models to the ECU 108.

The tow hook system 100 may include or be retro-fitted or otherwise coupled with the vehicle 102. The vehicle 102 is a conveyance capable of transporting a person, an object, or a permanently or temporarily affixed apparatus. The vehicle 102 may be a self-propelled wheeled conveyance, such as a car, a sports utility vehicle, a truck, a bus, a van or other motor, battery or fuel cell driven vehicle. For example, the vehicle 102 may be an electric vehicle, a hybrid vehicle, a hydrogen fuel cell vehicle, a plug-in hybrid vehicle or any other type of vehicle that has a fuel cell stack, a motor and/or a generator. Other examples of vehicles include bicycles, trains, planes, or boats, and any other form of conveyance that is capable of transportation. The vehicle 102 may be semi-autonomous or autonomous. That is, the vehicle 102 may be self-maneuvering and navigate without human input. An autonomous vehicle may have and use one or more sensors and/or a navigation unit to drive autonomously.

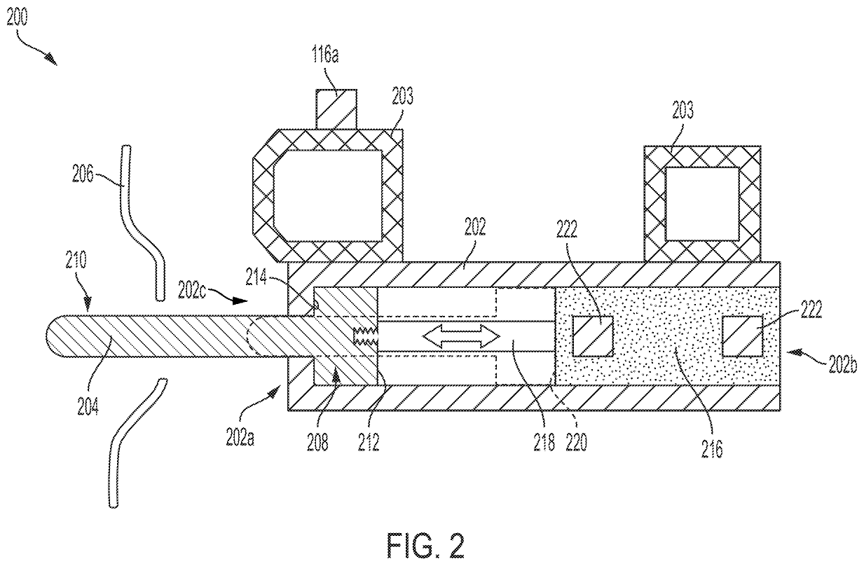

In various embodiments, the vehicle 102 may be configured to tow (e.g., be configured as a towing vehicle) another vehicle, trailer, etc. (e.g., a towed vehicle). A tow hook (e.g., tow hook 204 as shown in FIG. 2) may be used to secure and attach the towing vehicle to the towed vehicle. The towing vehicle may have a bumper and/or a connector that is used to connect the towing vehicle to a towing rod or bar, which is connected to a bumper and/or a connector of the towed vehicle. In various embodiments, the towed vehicle may be a boat, a flatbed trailer (with or without another vehicle stowed thereon), a box trailer, etc. In various aspects, the towing vehicle may be a motorhome or a recreational vehicle (RV), for example, configured to tow a towed vehicle (e.g., a sports utility vehicle (SUV)) where the towed vehicle is being flat towed (i.e., all wheels are on the ground).

The tow hook system 100 includes one or more processors, such as an electronic control unit (ECU) 108, and a memory 110. The tow hook system 100 may include other components, such as a navigation unit 112, one or more sensors 114 including one or more airbag sensors 116a, one or more external cameras 116b, a network access device 120, a user interface 122 and an output device 124. The tow hook system 100 may also include other sensors 136, such as a vehicle speed sensor, and a proximity sensor. The tow hook system 100 may also couple to, connect to, and/or include one or more vehicle components such as the motor and/or generator 126, the engine 128, the battery 130, the transmission 132 and/or the battery management control unit (BMCU) 134.

The ECU 108 may be implemented as a single ECU or as multiple ECUs. The ECU 108 may be electrically coupled to some or all of the other components within the vehicle 102, such as the motor and/or generator 126, the transmission 132, the engine 128, the battery 130, the battery management control unit (BMCU) 134, the memory 110, the network access device 120 and/or one or more sensors 114. The ECU 108 may include one or more processors or controllers specifically designed for predicting activities within the vehicle 102. The ECU 108 may generate predictive models and use machine learning algorithms to anticipate activities before the activities occur.

The ECU 108 may analyze the external and/or internal environment of the vehicle 102 and compare the data to a baseline and/or input the data into a model to anticipate, predict or otherwise determine any activities within the environment. If an activity is predicted or otherwise detected, the ECU 108 may act to record, document, provide or otherwise act to mitigate consequences of the activity. The ECU 108 may be coupled to a memory 110 and execute instructions that are stored in the memory 110.

The memory 110 may be coupled to the ECU 108 and store instructions that the ECU 108 executes. The memory 110 may include one or more of a Random Access Memory (RAM) or other volatile or non-volatile memory. The memory 110 may be a non-transitory memory or a data storage device, such as a hard disk drive, a solid-state disk drive, a hybrid disk drive, or other appropriate data storage, and may further store machine-readable instructions, which may be loaded and executed by the ECU 108. Moreover, the memory 110 may be used to record and store image data before, after and/or during the occurrence of the activity to document the activity.

The tow hook system 100 may include a user interface 122. The user interface 122 may be located in the head unit of the vehicle 102. The tow hook system 100 may display one or more notifications on the user interface 122. The one or more notifications on the user interface 122 may notify occupants of the vehicle 102 when the tow hook system 100 is initialized or activated. The user interface 122 may include an input/output device that receives user input from a user interface element, a button, a dial, a microphone, a keyboard, or a touch screen. For example, the user interface 122 may receive user input that may include configurations as to the amount of image data or the length of the video to record when an activity is detected. The user interface 122 may also receive user input that may include configurations as to when to activate sensors 114 (e.g., when to commence monitoring, how sensitive/what level of monitoring should occur) and when to transmit a notification to an output device 124. The output device 124 may be, for example, a display, such as a head up display (HUD) in the windshield, a multi-information display (MID) in the dashboard, and/or an in-vehicle infotainment (IVI) display. For example, each of the HUD, the MID, and the IVI display may display a notification icon indicating a shift in the load as exceeding a first threshold. In response, the driver may ignore the notification, clear the notification, or instruct the tow hook system 100 to continue to monitor the load until it exceeds a second threshold. Additionally, or alternatively, the output device 124 may be a display on a mobile device. A mobile device may also include a user interface 122. In other examples, the output device 124 may be a speaker, an audio and/or visual indicator, or a refreshable braille display.

The tow hook system 100 may include a network access device 120. The network access device 120 may include a communication port or channel, such as one or more of a Wi-Fi unit, a Bluetooth® unit, a radio frequency identification (RFID) tag or reader, or a cellular network unit for accessing a cellular network (such as 3G, 4G or 5G). The network access device 120 may transmit data to and receive data from the external database 104. For example, the ECU 108 may communicate with the external database 104 to obtain information about entities near the location of the vehicle 102, via the network 106.

The tow hook system may include a navigation unit 112 and/or one or more sensors 114. The navigation unit 112 may be integral to the vehicle 102 or a separate unit coupled to the vehicle 102, such as a personal device with navigation capabilities. When the navigation unit 112 is separate from the vehicle 102, the navigation unit 112 may communicate with the vehicle 102 via the network access device 120. The vehicle 102 may include a Global Positioning System (GPS) unit (not shown) for detecting location data including a current location of the vehicle 102 and date/time information instead of the navigation unit 112. In that regard, the ECU 108 may perform the functions of the navigation unit 112 based on data received from the GPS unit. At least one of the navigation unit 112 or the ECU 108 may predict or propose a route set that includes a starting location and a destination location. The navigation unit 112 or the ECU 108 may perform navigation functions. Navigation functions may include, for example, route and route set prediction, providing navigation instructions, and receiving user input such as verification of predicted routes and route sets or destinations.

The navigation unit 112 may provide and obtain navigational map information including location data, which may include a current location, a starting location, a destination location and/or a route between the starting location or current location and the destination location of the vehicle 102. The navigation unit 112 may include a memory (not shown) for storing the route data. The navigation unit 112 may receive data from other sensors capable of detecting data corresponding to location information. For example, the other sensors may include a gyroscope or an accelerometer.

The one or more sensors 114 may include one or more airbag sensors 116a, one or more external cameras 116b, and/or other sensors 136. The one or more airbag sensors 116a may be positioned on an external surface of the vehicle 102, such as on a frame or bumper (e.g., frame 203 in FIG. 2). The one or more airbag sensors 116a may be configured to detect a collision between the vehicle 102 and an external object (e.g., another vehicle, a wall, a street post, a pedestrian, etc.).

The one or more external cameras 116b may include multiple cameras positioned on the outside of the vehicle 102 to capture different views of the surrounding environment outside the vehicle 102. The one or more external cameras 116b may be positioned along the frame 203 of the vehicle 102. The different views of the surrounding environment may be used to form a panoramic or 360 degrees image of the surrounding environment outside the vehicle 102. The one or more external cameras 116b may capture image data that includes a single frame or image or a continuous video of the surrounding environment outside the vehicle 102, which allows the tow hook system 100 to capture activities outside of the vehicle 102 which may improve the detection of the collision.

The tow hook system 100 may couple to, connect to, and/or include one or more vehicle components. The one or more vehicle components may include a motor and/or generator 126. The motor and/or generator 126 may convert electrical energy into mechanical power, such as torque, and may convert mechanical power into electrical energy. The motor and/or generator 126 may be coupled to the battery 130. The motor and/or generator 126 may convert the energy from the battery 130 into mechanical power, and may provide energy back to the battery 130, for example, via regenerative braking. The vehicle 102 may include one or more additional power generation devices such as the engine 128 or a fuel cell stack (not shown). The engine 128 combusts fuel to provide power instead of and/or in addition to the power supplied by the motor and/or generator 126.

The battery 130 may be coupled to the motor and/or generator 126 and may provide electrical energy to and receive electrical energy from the motor and/or generator 126. The battery 130 may include one or more rechargeable batteries.

The BMCU 134 may be coupled to the battery 130 and may control and manage the charging and discharging of the battery 130. The BMCU 134, for example, may measure, using battery sensors, parameters used to determine the state of charge (SOC) of the battery 130. The BMCU 134 may control the battery 130.

The one or more vehicle components may include the transmission 132. The transmission 132 may have different gears and/or modes, such as park, drive and/or neutral and may shift between the different gears. The transmission 132 manages the amount of power that is provided to the wheels of the vehicle 102 given an amount of speed. The one or more vehicle components may include a steering device 138. The steering device 138 controls the direction of the movement of the vehicle 102 to follow a desired course.

The tow hook system 100 may include or be coupled to the external database 104. A database is any collection of pieces of information that is organized for search and retrieval, such as by a computer, and the database may be organized in tables, schemas, queries, reports, or any other data structures. A database may use any number of database management systems. The external database 104 may include a third-party server or website that stores or provides information. The information may include real-time information, periodically updated information, or user-inputted information. A server may be a computer in a network that is used to provide services, such as accessing files or sharing peripherals, to other computers in the network.

The external database 104 may be a relational database or behavioral model database that provides models of normal motions and/or features of different objects or individuals. The external database 104 may be updated and/or provide updates in real-time. The external database 104 may store and/or provide the models to the ECU 108.

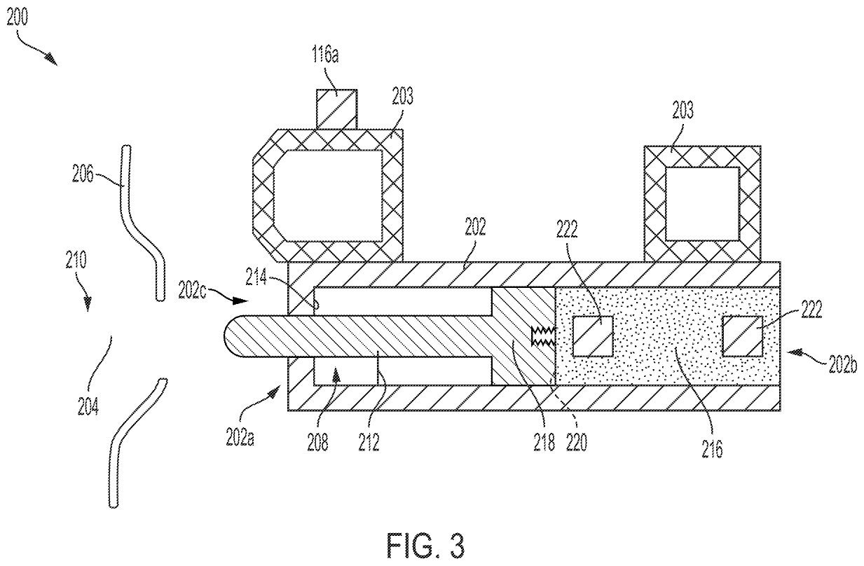

FIGS. 2 and 3 illustrate a tow hook assembly 200 for use with the took hook system 100 described herein. The tow hook assembly 200 includes a housing 202. The housing 202 may be coupled to a frame 203, or a bumper, of the vehicle 102. The housing 202 may have a first end 202a and a second end 202b opposite the first end 202a. The housing 202 may be configured to house various components of the tow hook assembly 200, as described herein.

The tow hook assembly 200 includes a tow hook 204. The tow hook 204 may be a carabiner hook, rope hook or other fastening, coupling, connecting or anchoring device that fastens, couples or connects to the towed object, such as a tow hitch of the towed object. For instance, the tow hook 204 may be fastened, coupled or otherwise secured to a tow rope. The tow hook 204 is configured to secure the towed object and allows the towed object to be pulled, moved or otherwise towed by the vehicle 102. The tow hook 204 may extend past a bumper panel 206 such that the tow hook 204 is easily accessed by a user. The tow hook 204 may have a distal end 210 and a proximal end 208 opposite the distal end 210. At least a portion of the proximal end 208 may be disposed within the housing 202. For instance, the housing 202 may include an opening 202c configured to allow the tow hook 204 to move proximally (e.g., in the direction of the second end 202b of the housing 202) and/or distally (e.g., in the direction of the first end 202a). The tow hook 204 may include an end portion 212 disposed on the proximal end 208 of the tow hook 204. The end portion 212 may be configured to prevent the tow hook 204 from being completely removed from the housing 202 when the tow hook 204 is moved distally. For instance, the end portion 212 is configured to be in confronting relation with an inside surface 214 of the housing 202 adjacent the opening 202c when the tow hook 204 is in a deployed position (e.g., see FIG. 2).

The tow hook assembly 200 includes a pneumatic actuator 216 and a translating portion 218 of the pneumatic actuator 216. The pneumatic actuator 216 and the translating portion 218 may be disposed within the housing 202. The translating portion 218 may be coupled to the distal end 210 of the tow hook 204. Accordingly, the pneumatic actuator 216 via the translating portion 218 may be configured to cause movement of the tow hook 204 in both the distal and proximal directions. For instance, the pneumatic actuator 216 may include a compression spring configured to bias the translating member 218 in the deployed position. In a stowed position (e.g., see FIG. 3), the end portion 212 is configured to be in confronting relation with an end surface 220 of the pneumatic actuator 216. To control a speed and/or a position of the tow hook 204, the pneumatic actuator 216 includes at least one quick exhaust valve 222.

In response to the airbag sensor 116a detecting a collision, the tow hook assembly 200 is activated. For instance, in the event of a crash, the airbag sensor 116a or secondary sensor (e.g., the external camera 116b) is configured to detect a crash, thus automatically activating the pneumatic actuator 216. That is, once the sensor detects an impending accident or crash, the pneumatic actuator 216 is automatically activated to retract the tow hook 204 completely into the housing 202. Accordingly, the tow hook 204 is retracted using the pneumatic actuator 216. This allows the crash structure of the vehicle 102 to function without being negatively impacted by the tow hook structure. Additionally, the user has the ability to deploy or retract the tow hook 204 as needed. For instance, the driver can keep the tow hook 204 stowed and electronically deploy the tow hook 204 when needed for vehicle recovery via the user interface 122. In addition or alternatively, once the speed sensor 136 detects the vehicle 102 travelling at a speed greater than a threshold (e.g., 25 mph), the pneumatic actuator 216 is automatically activated to retract the tow hook 204 completely into the housing 202.

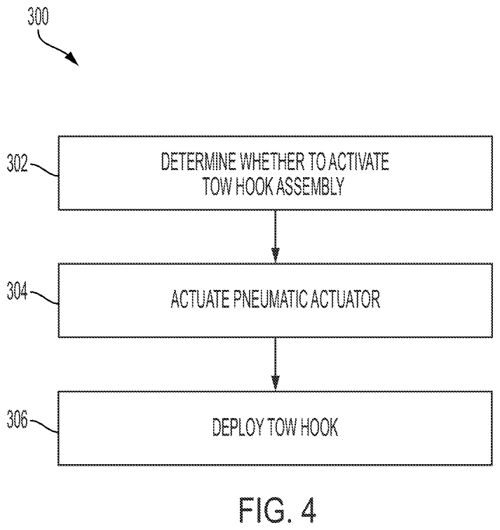

FIG. 4 is a flow diagram of an example process 300 for operating the tow hook assembly 200. One or more computers or one or more data processing apparatuses, for example, the ECU 108 of the tow hook system 100 of FIG. 1, appropriately programmed, may implement the process 300.

At 302, the tow hook system 100 determines whether to activate the tow hook assembly 200. For instance, the airbag sensor 116a may detect a collision. Accordingly, the tow hook assembly 200 may be activated. In various embodiments, the external camera 116b may detect the collision. Alternatively, the tow hook system 100 may be manually activated by the user, a front passenger, or by a remote user of an autonomous vehicle. For instance, the user may activate the tow hook system 100 via the user interface 122.

At 304, the tow hook system 100 actuates the pneumatic actuator 216. Accordingly, the pneumatic actuator 216 via the translating portion 218 causes the tow hook 204 to move proximally from a deployed position (e.g., see FIG. 2) to a stowed position (e.g., see FIG. 3). For instance, the compression spring of the pneumatic actuator 216 may bias the translating member 218 in the deployed position such that the end portion 212 of the tow hook 204 is in confronting relation with the inside surface 214 of the housing 202 adjacent the opening 202c. Once moved proximally, the end portion 212 is in confronting relation with the end surface 220 of the pneumatic actuator 216 in the stowed position. The at least one quick exhaust valve 222 controls a speed and/or a position of the tow hook 204.

At 306, the tow hook 204 may be deployed from the stowed position to the deployed position. For instance, the pneumatic actuator may be actuated to move the tow hook 204 distally. Alternatively, the user may manually deploy the tow hook 204 by applying a force in the distal direction to pull the tow hook 204 out of the housing 202 and past the frame 203.

Exemplary embodiments of the invention have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A tow hook system for a vehicle, comprising:
a sensor configured to detect a collision of the vehicle; and
an electronic control unit coupled to the sensor and configured to:
obtain, from the sensor, the collision detection, and
activate a tow hook assembly based on the collision detection.

2. The tow hook system of claim 1, wherein the sensor includes at least one of an airbag sensor, an external camera configured to capture different views of an exterior of the vehicle, or a proximity sensor.

3. The tow hook system of claim 1, wherein the tow hook assembly comprises a housing coupled to a frame of the vehicle, the housing having a first end, a second end opposite the first end, and an opening.

4. The tow hook system of claim 3, wherein the tow hook assembly comprises a tow hook having a distal end and a proximal end opposite the distal end, the tow hook assembly at least partially housed by the housing such that the tow hook is configured to move through the opening of the housing.

5. The tow hook system of claim 4, wherein the tow hook further comprises an end portion disposed on the proximal end of the tow hook, the end portion configured to prevent the tow hook from being removed from the housing such that the end portion is configured to be in confronting relation with an inside surface of the housing adjacent the opening when the tow hook is in a deployed position.

6. The tow hook system of claim 5, wherein the tow hook assembly further comprises a pneumatic actuator configured to be disposed with the housing, the pneumatic actuator having a translating portion coupled to the distal end of the tow hook.

7. The tow hook system of claim 6, wherein the pneumatic actuator is configured to cause movement of the tow hook via the translating portion.

8. The tow hook system of claim 7, wherein the end portion of the tow hook is configured to be in confronting relation with an end surface of the pneumatic actuator in a stowed position.

9. The tow hook system of claim 8, wherein the pneumatic actuator further comprises at least one quick exhaust valve configured to control a speed and/or a position of the tow hook.

10. The tow hook system of claim 1, further comprising a user interface configured to receive commands from the user.

11. The tow hook system of claim 10, wherein the commands from the user include deploying and stowing the tow hook assembly.

12. The tow hook system of claim 1, wherein the vehicle is an autonomous vehicle.

13. A tow hook assembly of a vehicle, the tow hook assembly comprising:
a housing coupled to a frame of the vehicle, the housing having a first end, a second end opposite the first end, and an opening:
a tow hook having a distal end and a proximal end opposite the distal end, the tow hook at least partially housed by the housing such that the tow hook is configured to move through the opening of the housing between the first end and the second end: and
a pneumatic actuator coupled to the tow hook, the pneumatic actuator configured to cause the movement of the tow hook.

14. The tow hook assembly of claim 13, wherein the tow hook is at least one of a carabiner hook, a rope hook or other fastening, coupling, connecting or anchoring device.

15. The tow hook assembly of claim 13, wherein the tow hook further comprises an end portion disposed on the proximal end of the tow hook.

16. The tow hook assembly of claim 15, wherein the end portion is configured to prevent the tow hook from being removed from the housing such that the end portion is configured to be in confronting relation with an inside surface of the housing adjacent the opening when the tow hook is in a deployed position.

17. The tow hook assembly of claim 13, wherein the pneumatic actuator comprises a translating portion coupled to the distal end of the tow hook, the pneumatic actuator and the translating portion configured to be disposed within the housing, the pneumatic actuator configured to cause the movement of the tow hook via the translating portion.

18. The tow hook assembly of claim 13, wherein the end portion of the tow hook is configured to be in confronting relation with an end surface of the pneumatic actuator in a stowed position.

19. The tow hook assembly of claim 10, wherein the pneumatic actuator further comprises at least one quick exhaust valve configured to control a speed and/or a position of the tow hook.

20. A method for operating the tow hook assembly of a vehicle, the method comprising:
determining, by a processor, to activate a tow hook assembly in response to a sensor detecting a collision of the vehicle;
actuating, by the processor, a pneumatic actuator of the tow hook assembly in response to the collision detection; and
stowing, via the pneumatic actuator, a tow hook coupled to the pneumatic actuator.
